(19) United States
(12) Patent Application Publication
(10) Pub. No.: US 2023/0084534 A1
(43) Pub. Date: Mar. 16, 2023

(54) NETWORK-TRAFFIC-FLOW VISUALIZATION USING PARALLEL SETS

(71) Applicant: ARRIS Enterprises LLC, Suwanee, GA (US)

(72) Inventor: Ching-Hung Chen, Taipei (TW)

(73) Assignee: ARRIS Enterprises LLC, Suwanee, GA (US)

(21) Appl. No.: 17/940,106

(22) Filed: Sep. 8, 2022

Related U.S. Application Data
(60) Provisional application No. 63/242,558, filed on Sep. 10, 2021.

(51) Int. Cl. H04L 43/045; H04L 43/0876; H04L 41/22

(52) U.S. Cl. CPC H04L 43/045; H04L 41/22; H04L 43/0876

(57) ABSTRACT

A computer system is described. During operation, the computer system receives, associated with communication network devices, operating information during time intervals, where given operating information includes operating information associated with a given communication network device during a given time interval. Then, the computer system computes communication-performance metrics associated with operation of at least a portion of the network based at least in part on the operating information. Next, the computer system provides information specifying a user interface, where the information corresponds to a graph of data frequencies for a given communication-performance metric and interactions between at least a subset of the communication network devices or between at least one of the communication network devices and one or more clients that are connected or associated with at least the one of the communication network devices, and where the data frequencies and the interactions specify traffic flows in the network.

### CROSS REFERENCE TO RELATED APPLICATIONS

This application claims priority under 35 U.S.C. 119(e) to U.S. Provisional Application Serial Number 63/242,558, “Network-Traffic-Flow Visualization Using Parallel Sets,” filed on Sep. 10, 2021, by Ching-Hung Chen, the contents of which are herein incorporated by reference.

### FIELD

The described embodiments relate to techniques for providing dynamic and interactive visualizations of network-traffic flows via a user interface.

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

In order to facilitate management and, as needed, configuration of a network, it is often useful to provide summary information about communication-performance metrics associated with network operation. For example, an analytical service associated with a network may collect operating information from communication network devices (such as access points, routers and/or switches) in the network, and may compute and present summary information of communication-performance metrics at different hierarchical levels in the network (such as for groups of communication network devices, zones, subnets, etc.). Typically, the summary information is presented in a dashboard or user interface to a network operator or administrator, which facilitates situational awareness and improved decision-making regarding current network operation and/or potential configuration changes.

However, there are often limitations in how the summary information is presented. For example, large flat tables of statistical often unintentionally mask dynamic changes in numerical values, e.g., as a function of time. Similarly, many existing graphical techniques (such as scatter plots, histograms, pie charts and bar charts) typically present features independently, which can inadvertently obscure the complexities in high-dimensional datasets, such as those associated with networks. Consequently, it can be difficult for network operators and administrators to correctly interpret the presented summary information and, therefore, to correctly determine subsequent actions, such as network configuration changes.

### SUMMARY

A computer system that provides information specifying a user interface is described. This computer system may include an interface circuit that communicates with communication network devices (such as one or more access points, one or more switches and/or one or more routers) in a network. During operation, the computer system receives, associated with the communication network devices, operating information during time intervals, where given operating information includes operating information associated with a given communication network device during a given time interval. Then, the computer system computes one or more communication-performance metrics associated with operation of at least a portion of the network based at least in part on the operating information. Next, the computer system provides the information specifying the user interface (e.g., to or on a display), where the information corresponds to a graph of data frequencies for a given communication-performance metric and interactions between at least a subset of the communication network devices or between at least one of the communication network devices and one or more clients that are connected or associated with at least the one of the communication network devices, and where the data frequencies and the interactions specify traffic flows in the network.

Note that the graph may include a parallel sets representation of the data frequencies and the interactions.

Moreover, widths of spatial features in the graph may correspond to values of the given communication-performance metric.

Furthermore, the given communication-performance metric may include: a data rate, a throughput, or a capacity.

Additionally, the traffic flows may be associated with different applications that are used by the one or more clients.

In some embodiments, the data frequencies and the interactions correspond to one or more wireless local area networks that are hosted by at least the one of the communication network devices.

Moreover, the graph may spatially segregate the traffic flows associated with different communication network devices in at least the subset of the communication network devices or associated with different clients in the one or more clients.

Furthermore, the graph may indicate roaming between communication network devices in at least the subset of the communication network devices.

Additionally, the graph may be dynamically updated based at least in part on additional operating information that is received.

Note that the operating information may be received from a controller of the communication network devices.

In some embodiments, the computer system receives user-interface-activity information corresponding to user interaction with a user-interface device. In response, the computer system may modify the graph. For example, the computer system may add another communication-performance metric to the graph or remove the given communication-performance metric from the graph based at least in part on the user-interface-activity information. Alternatively or additionally, the computer system may change at least the subset of the communication network devices or the one or more clients in the graph based at least in part on the user-interface-activity information.

Another embodiment provides a computer-readable storage medium with program instructions for use with the computer system. When executed by the computer system, the program instructions cause the computer system to perform at least some of the aforementioned operations in one or more of the preceding embodiments.

Another embodiment provides a method, which may be performed by the computer system. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for providing information specifying a user interface using a computer system in FIG. 1 in accordance with an embodiment of the present disclosure.

FIG. 3 is a drawing illustrating an example of communication among an access point, a computer system and a controller in FIG. 1 in accordance with an embodiment of the present disclosure.

FIG. 4 is a drawing illustrating an example of operating information in accordance with an embodiment of the present disclosure.

FIG. 5 is a drawing illustrating an example of pie charts summarizing top communication network devices for a communication-performance metric at different levels in a network hierarchy in accordance with an embodiment of the present disclosure.

FIG. 6 is a drawing illustrating an example of a user interface with a graph representing parallel sets in accordance with an embodiment of the present disclosure.

FIG. 7 is a drawing illustrating an example of a user interface with a graph representing parallel sets in accordance with an embodiment of the present disclosure.

FIG. 8 is a drawing illustrating an example of a user interface with a graph representing parallel sets in accordance with an embodiment of the present disclosure.

FIG. 9 is a block diagram illustrating an example of an electronic device in accordance with an embodiment of the present disclosure.

### DETAILED DESCRIPTION

Note that like reference numerals refer to corresponding parts throughout the drawings. Moreover, multiple instances of the same part are designated by a common prefix separated from an instance number by a dash.

A computer system is described. During operation, the computer system receives, associated with the communication network devices, operating information during time intervals, where given operating information includes operating information associated with a given communication network device during a given time interval. Then, the computer system computes one or more communication-performance metrics associated with operation of at least a portion of the network based at least in part on the operating information. Next, the computer system provides information specifying a user interface, where the information corresponds to a graph of data frequencies for a given communication-performance metric and interactions between at least a subset of the communication network devices or between at least one of the communication network devices and one or more clients that are connected or associated with at least the one of the communication network devices, and where the data frequencies and the interactions specify traffic flows in the network. Note that the graph may include a parallel sets representation of the data frequencies and the interactions.

By providing the information specifying the user interface, these communication techniques may facilitate improved understanding and management of the network. For example, the graph may be dynamically updated based at least in part on additional operating information is received, and a user (such as a network operator or administrator) may interact with the user interface to modify the graph. Moreover, the graph may accurately represent multi-dimensional and interacting features in a transparent and intuitive manner for the user. Consequently, the communication techniques may assist the user in decision-making, such as a remedial action to perform in the event of a network problem or a network-configuration change that may improve network performance. Therefore, the communication techniques may increase the satisfaction of users of the network and/or the computer systems, such as the network operator or administrator and/or customers.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

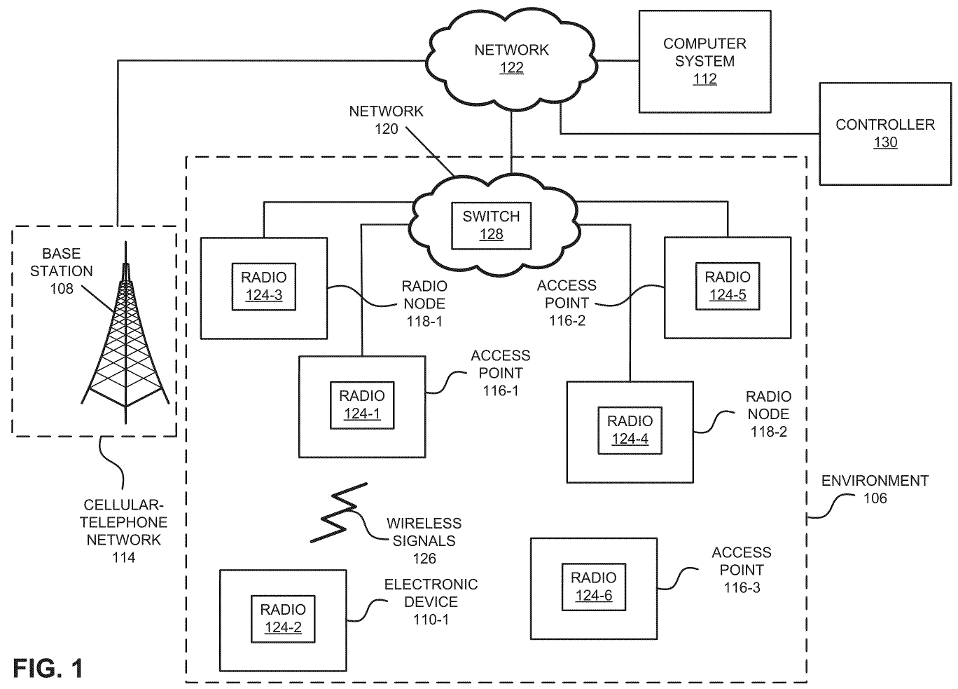

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, computer system 112 and/or controller 130 (which may be a local or a cloud-based controller that manages and/or configures access points 116, radio nodes 118 and/or switch 128, or that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

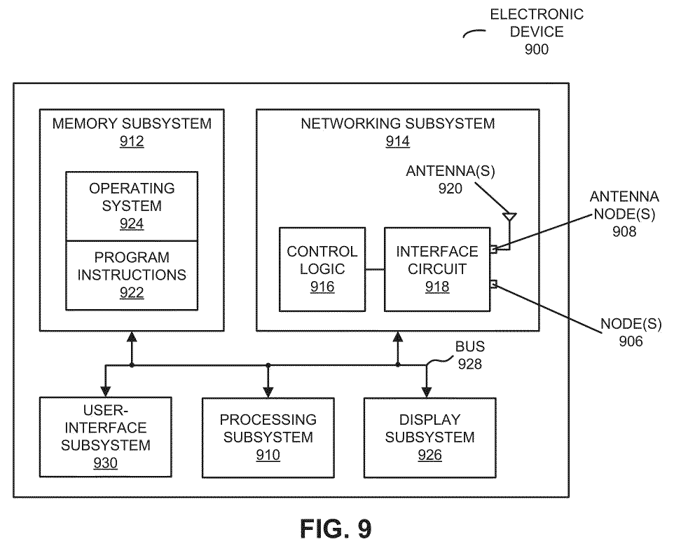

As described further below with reference to FIG. 9, electronic devices 110, computer system 112, access points 116, radio nodes 118, switch 128 and controller 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it can be difficult to present information about network operation in a manner that is clear and understandable to a user, such as a network operator or administrator. In addition, existing graphical techniques often inadvertently obscure the complexities in high-dimensional datasets, such as those associated with networks.

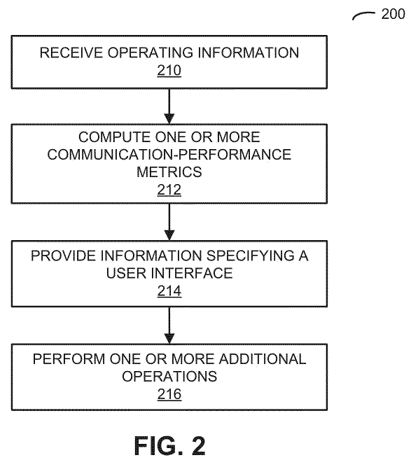

Moreover, as described further below with reference to FIGS. 2-8, in order to addresses these difficulties, computer system 112 (which may include one or more computers) may implemented one or more embodiments of the communication techniques. Notably, one or more communication network devices (such as one or more access points 116, one or more radio nodes 118 and/or switch 128) may routinely provide operating information during time intervals (such as 1 s, 5 s, 10 s, 30 s, 1 min, 3 min, 5 min or 10 min) to computer system 112 via controller 130, where given operating information includes operating information associated with a given communication network device during a given time interval.

After receiving the operating information, computer system 112 may compute one or more communication-performance metrics (such as a data rate, a throughput and/or a capacity) associated with operation of at least a portion of the network based at least in part on the operating information. Then, computer system 112 may provide information specifying a user interface (e.g., to or on a display), where the information corresponds to a graph of data frequencies for a given communication-performance metric and interactions between at least a subset of the communication network devices or between at least one of the communication network devices and one or more clients (such as electronic device 110-1) that are connected or associated with at least the one of the communication network devices. Note that the data frequencies and the interactions may specify traffic flows in the network.

Moreover, computer system 112 may dynamically update the user interface and/or the graph based at least in part on additional operating information that is received from one or more of the communication network devices. Furthermore, a user of computer system 112 (such as a network operator or administrator) may interact with and may update the graph and/or the user interact. For example, the user may interact with a user-interface device (such as a keyboard, a mouse, a trackpad, a stylus, a touch-sensitive display and/or a voice interface) to specify a modification to the user interface and/or the graph. After receiving user-interface-activity information corresponding to user interaction with the user-interface device, computer system 112 may modify the user interface and/or the graph. For example, computer system 112 may add another communication-performance metric to the graph or remove the given communication-performance metric from the graph based at least in part on the user-interface-activity information. Alternatively or additionally, computer system 112 may change at least the subset of the communication network devices or the one or more clients in the graph based at least in part on the user-interface-activity information.

In these ways, the communication techniques may accurately represent multidimensional and interacting features associated with operation of the network (such as the traffic flows) in a transparent and intuitive manner for the user. These dynamic and interactive visualizations may facilitate improved understanding and management of the network. Notably, the communication techniques may assist the user in decision-making, such as a remedial action to perform in the event of a network problem or a network-configuration change that may improve network performance.

We now describe embodiments of the method. FIG. 2 presents a flow diagram illustrating an example of a method 200 for providing information specifying a user interface, which may be performed by a computer system (such as computer system 112). During operation, the computer system may receive, associated with communication network devices in a network, operating information (operation 210), where given operating information includes operating information associated with a given communication network device during a given time interval. Note that the operating information may be received from a controller of the communication network devices.

Then, the computer system may compute one or more communication-performance metrics (operation 212) associated with operation of at least a portion of the network based at least in part on the operating information. For example, the computing may involve aggregating measurements in different time intervals and/or that are associated with different: components in the network, clients, and/or applications executed by or associated with one or more clients.

Next, the computer system may provide the information (operation 214) specifying the user interface (e.g., to or on a display), where the information corresponds to a graph of data frequencies for a given communication-performance metric and interactions between at least a subset of the communication network devices or between at least one of the communication network devices and one or more clients that are connected or associated with at least the one of the communication network devices, and where the data frequencies and the interactions specify traffic flows in the network.

Note that the graph may include a parallel sets representation of the data frequencies and the interactions. Moreover, widths of spatial features in the graph may correspond to values of the given communication-performance metric. Furthermore, the given communication-performance metric may include: a data rate, a throughput, or a capacity. Additionally, the traffic flows may be associated with different applications that are used by the one or more clients. In some embodiments, the data frequencies and the interactions correspond to one or more wireless local area networks that are hosted by at least the one of the communication network devices.

Moreover, the graph may spatially segregate the traffic flows associated with different communication network devices in at least the subset of the communication network devices or associated with different clients in the one or more clients. Furthermore, the graph may indicate roaming between communication network devices in at least the subset of the communication network devices.

In some embodiments, the computer system optionally performs one or more additional operations (operation 216). For example, the graph may be dynamically updated based at least in part on additional operating information that is received.

Moreover, the computer system may receive user-interface-activity information corresponding to user interaction with a user-interface device. In response, the computer system may modify the graph. For example, the computer system may add another communication-performance metric to the graph or remove the given communication-performance metric from the graph based at least in part on the user-interface-activity information. Alternatively or additionally, the computer system may change at least the subset of the communication network devices or the one or more clients in the graph based at least in part on the user-interface-activity information.

In some embodiments of method 200, there may be additional or fewer operations. Furthermore, the order of the operations may be changed, and/or two or more operations may be combined into a single operation. For example, in some embodiments, at least some of the operations in the communication techniques may be performed by controller 130. Thus, in some embodiments, the communication techniques may be performed in a centralized and/or a distributed manner.

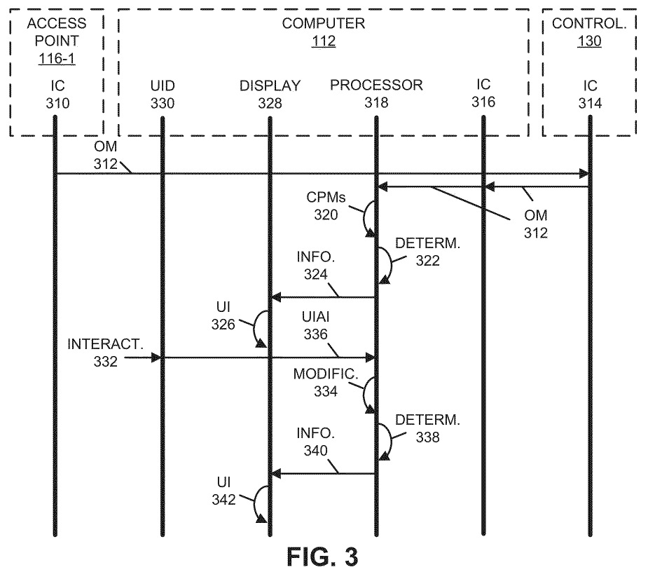

Embodiments of the communication techniques are further illustrated in FIG. 3, which presents a drawing illustrating an example of communication among access point 116-1, computer system 112 and controller 130. An interface circuit (IC) 310 in access point 116-1 may provide operating information (OI) 312 to controller 130.

After or while receiving operating information 312 from access point 116-1, an interface circuit 314 in controller 130 may provide operating information 312 to computer system 112. Moreover, after receiving operating information 312, an interface circuit 316 in computer system 112 may provide operating information 312 to a processor 318 in computer system 112.

Processor 318 may compute one or more communication-performance metrics CPMs 320 associated with operation of at least a portion of a network based at least in part on operating information 312. Next, processor 318 may determine 322 and then may provide information 324 specifying a user interface (UI) 326. For example, information 324 may be provided to a display 328 in computer system 112, which may display user interface 326. Note that information 324 may correspond to a graph of data frequencies for a given communication-performance metric and interactions between at least a subset of the communication network devices or between at least one of the communication network devices and one or more clients that are connected or associated with at least the one of the communication network devices. Moreover, the data frequencies and the interactions may specify traffic flows in the network.

In some embodiments, a user of computer system 112 (such as a network operator or administrator) may interact 332 with a user-interface device (UID) 330 (such as a keyboard, a mouse, a trackpad, a stylus, a touch-sensitive display and/or a voice interface) to specify a modification 334 to the graph. After this user interaction, user-interface device 330 may provide user-interface-activity information (UIAI) 336 corresponding to the user interaction 332 to processor 318. Moreover, processor 318 may compute modification 334 based at least in part on user-interface-activity information 336. Then, processor 318 may determine 338 and then may provide information 340 specifying a modified user interface 342 based at least in part on modification 334. For example, information 340 may be provided to display 328, which may display user interface 342.

While FIG. 3 illustrates communication between components using unidirectional or bidirectional communication with lines having single arrows or double arrows, in general the communication in a given operation in this figure may involve unidirectional or bidirectional communication. Moreover, while FIG. 3 illustrates operations being performed sequentially or at different times, in other embodiments at least some of these operations may, at least in part, be performed concurrently or in parallel.

We now further describe the communication techniques. Communication network devices periodically (such as every 90 s or 180 s) report statistics and/or events (which are sometimes referred to collectively as ‘operating information’) to a controller. For example, the operating information may include information, such as: a number of cloud connections, network usage, applications being used by users (e.g., a Web browser), etc. Note that some of the operating information may depend on client behavior (such as when a client joints or leaves a network), while other operating information may be associated with a given communication network device (such as status information).

A computer system in or associated with the controller may process the operating information. For example, an analytical service in the computer system may analyze the operating information and may present one or more graphs of data frequencies for one or more communication-performance metrics and interactions between at least a subset of the communication network devices or between at least one of the communication network devices and one or more clients that are connected or associated with at least the one of the communication network devices. Moreover, the data frequencies and the interactions specify traffic flows in the network.

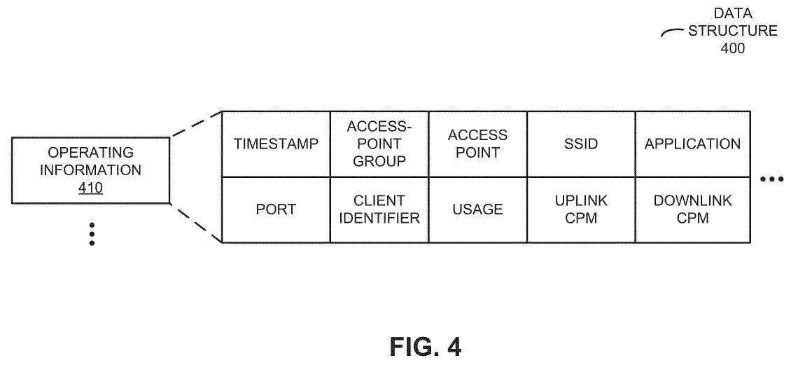

FIG. 4 presents a drawing illustrating an example of operating information 410 in a data structure 400. This operating information may correspond to a traffic flow during a client session from a client to and/or from an application (such as a search engine or a Web browser). For example, the operating information may include multi-dimensional data of a traffic footprint associated with one or more clients. Notably, as shown in FIG. 4, the operating information may include: application, a service set identifier (SSID), an access point, a client identifier (such as a media access control or MAC address), a timestamp, location information (such as 3D coordinates and/or a location in a network), an uplink communication-performance metric, and/or a downlink communication-performance metric.

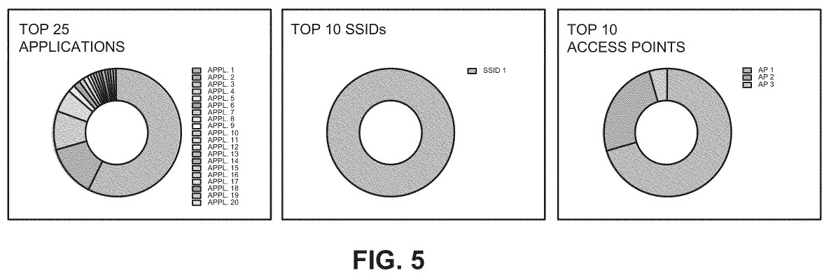

Typically, an analytical service may present one-dimensional representations of a communication-performance metric, such as throughput. This is shown in FIG. 5, which presents a drawing illustrating an example of pie charts summarizing top communication network devices for a communication-performance metric at different levels in a network hierarchy. For example, the pie charts shown in FIG. 5 indicate the communication performance devices having the highest throughput for applications, SSIDs and access points in a network. However, these representations do not allow a user to visual how traffic flows, e.g., traffic flows associated with an application, such as a search engine, a Web browser, a movie streaming service, a uniform resource locator (URL), etc.

In order to address these challenges, in the disclosed communication techniques parallel sets are used to facilitate multi-dimensional visualization and interactive exploration of different dimensions or features, such as categorical and real-valued data. Notably, a user interface may provide a graph that uses a parallel sets representation of data frequencies instead of the individual data points for the real-valued data and interactions between components and/or clients in a network. The graph may include axes laid out as parallel coordinates with boxes representing categories, such as different components, applications and/or clients. Moreover, curves (such as parallelograms) between the categories may indicate relations or interactions between the categories, such as traffic flows in the network. Note that the traffic flow may be end-to-end in the network, such as from a client to an application (or vice versa).

The user interface may also allow a user to interactively remap the data in the graph into different categorizations and, thus, to consider more data dimensions or features during exploration and analysis than is usually possible. Furthermore, the user interface may include meta-level, semantic representations of the data. For example, a cross product of two or more dimensions or features may be performed automatically, thereby complementing the dynamic and interactive visualization.

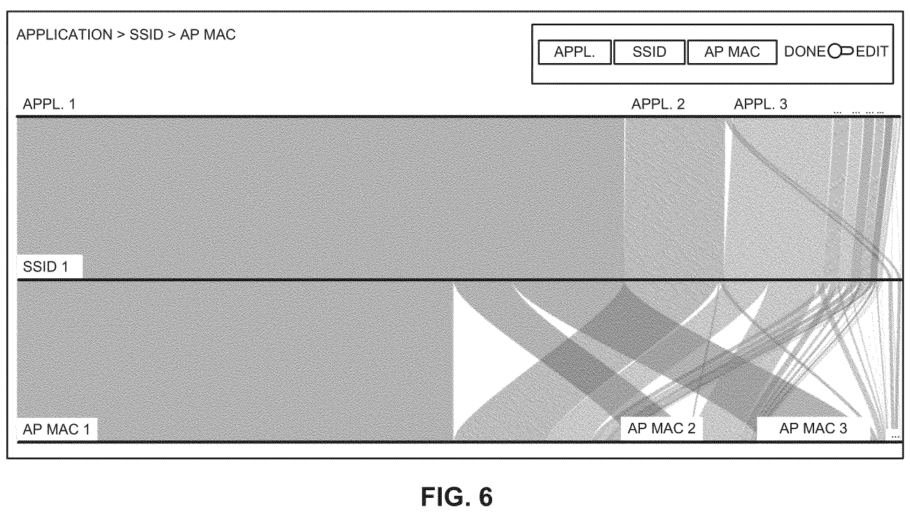

FIG. 6 presents a drawing illustrating an example of a user interface with a graph representing parallel sets. Notably, the graph shown in FIG. 6 corresponds to the data shown in FIG. 5. However, the graph shown in FIG. 6 provides a more understandable and intuitive representations of the traffic flows in the network associated with the application.

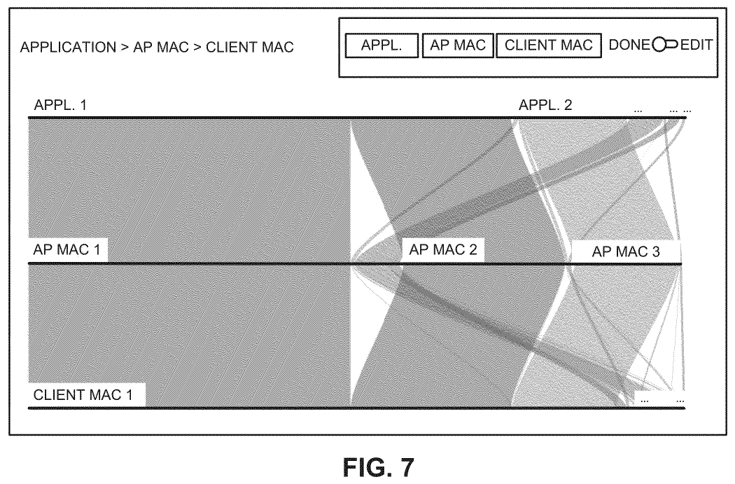

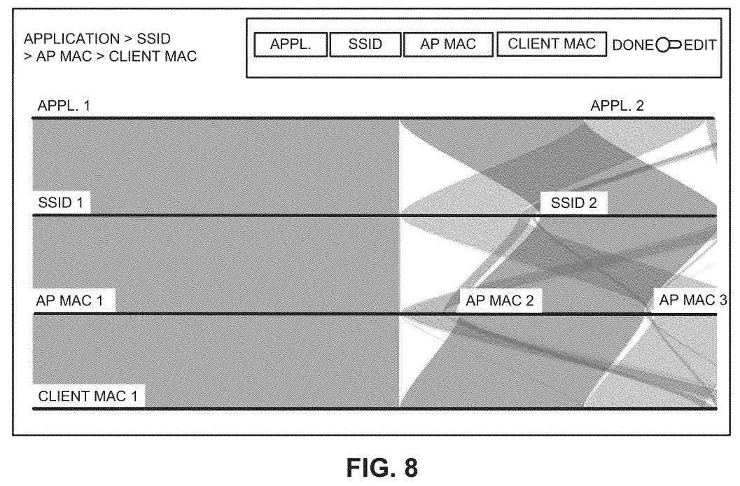

FIGS. 7 and 8 present a drawing illustrating an example of a user interfaces with graphs representing parallel sets. In FIGS. 7 and 8, traffic flows associated with multiple levels in a network hierarchy are presented. These traffic flows also illustrate roaming in the network.

We now describe embodiments of an electronic device, which may perform at least some of the operations in the communication techniques. FIG. 9 presents a block diagram illustrating an example of an electronic device 900 in accordance with some embodiments, such as one of: base station 108, one of electronic devices 110, computer system 112, one of access points 116, one of radio nodes 118, switch 128 or controller 130. This electronic device includes processing subsystem 910, memory subsystem 912, and networking subsystem 914. Processing subsystem 910 includes one or more devices configured to perform computational operations. For example, processing subsystem 910 can include one or more microprocessors, graphics processing units (GPUs), ASICs, microcontrollers, programmable-logic devices, and/or one or more digital signal processors (DSPs).

Memory subsystem 912 includes one or more devices for storing data and/or instructions for processing subsystem 910 and networking subsystem 914. For example, memory subsystem 912 can include DRAM, static random access memory (SRAM), and/or other types of memory. In some embodiments, instructions for processing subsystem 910 in memory subsystem 912 include: one or more program modules or sets of instructions (such as program instructions 922 or operating system 924, such as Linux, UNIX, Windows Server, or another customized and proprietary operating system), which may be executed by processing subsystem 910. Note that the one or more computer programs, program modules or instructions may constitute a computer-program mechanism. Moreover, instructions in the various modules in memory subsystem 912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 910.

In addition, memory subsystem 912 can include mechanisms for controlling access to the memory. In some embodiments, memory subsystem 912 includes a memory hierarchy that comprises one or more caches coupled to a memory in electronic device 900. In some of these embodiments, one or more of the caches is located in processing subsystem 910.

In some embodiments, memory subsystem 912 is coupled to one or more highcapacity mass-storage devices (not shown). For example, memory subsystem 912 can be coupled to a magnetic or optical drive, a solid-state drive, or another type of mass-storage device. In these embodiments, memory subsystem 912 can be used by electronic device 900 as fast-access storage for often-used data, while the mass-storage device is used to store less frequently used data.

Networking subsystem 914 includes one or more devices configured to couple to and communicate on a wired and/or wireless network (i.e., to perform network operations), including: control logic 916, an interface circuit 918 and one or more antennas 920 (or antenna elements). (While FIG. 9 includes one or more antennas 920, in some embodiments electronic device 900 includes one or more nodes, such as antenna nodes 908, e.g., a metal pad or a connector, which can be coupled to the one or more antennas 920, or nodes 906, which can be coupled to a wired or optical connection or link. Thus, electronic device 900 may or may not include the one or more antennas 920. Note that the one or more nodes 906 and/or antenna nodes 908 may constitute input(s) to and/or output(s) from electronic device 900.) For example, networking subsystem 914 can include a Bluetooth™ networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 900 may be adapted or changed using pattern shapers (such as directors or reflectors) and/or one or more antennas 920 (or antenna elements), which can be independently and selectively electrically coupled to ground to steer the transmit antenna pattern in different directions. Thus, if one or more antennas 920 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 900 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 900 may use the mechanisms in networking subsystem 914 for performing simple wireless communication between the electronic devices, e.g., transmitting advertising or beacon frames and/or scanning for advertising frames transmitted by other electronic devices as described previously.

Within electronic device 900, processing subsystem 910, memory subsystem 912, and networking subsystem 914 are coupled together using bus 928. Bus 928 may include an electrical, optical, and/or electro-optical connection that the subsystems can use to communicate commands and data among one another. Although only one bus 928 is shown for clarity, different embodiments can include a different number or configuration of electrical, optical, and/or electro-optical connections among the subsystems.

In some embodiments, electronic device 900 includes a display subsystem 926 for displaying information on a display, which may include a display driver and the display, such as a liquid-crystal display, a multi-touch touchscreen, etc.

Moreover, electronic device 900 may include a user-interface subsystem 930, such as: a mouse, a keyboard, a trackpad, a stylus, a voice-recognition interface, and/or another human-machine interface. In some embodiments, user-interface subsystem 930 may include or may interact with a touch-sensitive display in display subsystem 926.

Electronic device 900 can be (or can be included in) any electronic device with at least one network interface. For example, electronic device 900 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 900, in alternative embodiments, different components and/or subsystems may be present in electronic device 900. For example, electronic device 900 may include one or more additional processing subsystems, memory subsystems, networking subsystems, and/or display subsystems. Additionally, one or more of the subsystems may not be present in electronic device 900. Moreover, in some embodiments, electronic device 900 may include one or more additional subsystems that are not shown in FIG. 9. Also, although separate subsystems are shown in FIG. 9, in some embodiments some or all of a given subsystem or component can be integrated into one or more of the other subsystems or component(s) in electronic device 900. For example, in some embodiments instructions 922 is included in operating system 924 and/or control logic 916 is included in interface circuit 918.

Moreover, the circuits and components in electronic device 900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 914 and/or of electronic device 900. The integrated circuit may include hardware and/or software mechanisms that are used for transmitting wireless signals from electronic device 900 and receiving signals at electronic device 900 from other electronic devices. Aside from the mechanisms herein described, radios are generally known in the art and hence are not described in detail. In general, networking subsystem 914 and/or the integrated circuit can include any number of radios. Note that the radios in multiple-radio embodiments function in a similar way to the described single-radio embodiments.

In some embodiments, networking subsystem 914 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi, LTE and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 922, operating system 924 (such as a driver for interface circuit 918) or in firmware in interface circuit 918. Alternatively or additionally, at least some of the operations in the communication techniques may be implemented in a physical layer, such as hardware in interface circuit 918.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with communication network devices in a network, wherein the computer system is configured to:
receive, associated with the communication network devices, operating information during time intervals, wherein given operating information comprises operating information associated with a given communication network device during a given time interval;
compute one or more communication-performance metrics associated with operation of at least a portion of the network based at least in part on the operating information; and
provide information specifying a user interface, wherein the information corresponds to a graph of data frequencies for a given communication-performance metric and interactions between at least a subset of the communication network devices or between at least one of the communication network devices and one or more clients that are connected or associated with at least the one of the communication network devices, and
wherein the data frequencies and the interactions specify traffic flows in the network.

2. The computer system of claim 1, wherein the graph comprises a parallel sets representation of the data frequencies and the interactions.

3. The computer system of claim 1, wherein widths of spatial features in the graph correspond to values of the given communication-performance metric.

4. The computer system of claim 1, wherein the given communication-performance metric comprises: a data rate, a throughput, or a capacity.

5. The computer system of claim 1, wherein the traffic flows are associated with different applications that are used by the one or more clients.

6. The computer system of claim 1, wherein the data frequencies and the interactions correspond to one or more wireless local area networks that are hosted by at least the one of the communication network devices.

7. The computer system of claim 1, wherein the graph spatially segregates the traffic flows associated with different communication network devices in at least the subset of the communication network devices or associated with different clients in the one or more clients.

8. The computer system of claim 1, wherein the graph indicates roaming between communication network devices in at least the subset of the communication network devices.

9. The computer system of claim 1, wherein the computer system is configured to dynamically update the graph based at least in part on additional operating information that is received.

10. The computer system of claim 1, wherein the operating information is received from a controller of the communication network devices.

11. The computer system of claim 1, wherein the computer system is configured to:
receive user-interface-activity information corresponding to user interaction with a user-interface device; and
modify the graph based at least in part on the user-interface-activity information.

12. The computer system of claim 11, wherein the modification comprises adding another communication-performance metric to the graph or removing the given communication-performance metric from the graph based at least in part on the user-interface-activity information.

13. The computer system of claim 11, wherein the modification comprises changing at least the subset of the communication network devices or the one or more clients in the graph based at least in part on the user-interface-activity information.

14. A non-transitory computer-readable storage medium for use in conjunction with a computer system, the computer-readable storage medium storing program instructions that, when executed by the computer system, cause the computer system to perform operations comprising:
receiving, associated with communication network devices in a network, operating information during time intervals, wherein given operating information comprises operating information associated with a given communication network device during a given time interval;
computing one or more communication-performance metrics associated with operation of at least a portion of the network based at least in part on the operating information; and
providing information specifying a user interface, wherein the information corresponds to a graph of data frequencies for a given communication-performance metric and interactions between at least a subset of the communication network devices or between at least one of the communication network devices and one or more clients that are connected or associated with at least the one of the communication network devices, and
wherein the data frequencies and the interactions specify traffic flows in the network.

15. The non-transitory computer-readable storage medium of claim 14, wherein the graph comprises a parallel sets representation of the data frequencies and the interactions.

16. The non-transitory computer-readable storage medium of claim 14, wherein the operations comprise:
receiving user-interface-activity information corresponding to user interaction with a user-interface device; and
modifying the graph based at least in part on the user-interface-activity information.

17. A method for providing information specifying a user interface, comprising:
by a computer system:
receiving, associated with communication network devices in a network, operating information during time intervals, wherein given operating information comprises operating information associated with a given communication network device during a given time interval;
computing one or more communication-performance metrics associated with operation of at least a portion of the network based at least in part on the operating information; and
providing the information specifying the user interface, wherein the information corresponds to a graph of data frequencies for a given communication-performance metric and interactions between at least a subset of the communication network devices or between at least one of the communication network devices and one or more clients that are connected or associated with at least the one of the communication network devices, and
wherein the data frequencies and the interactions specify traffic flows in the network.

18. The method of claim 17, wherein the graph comprises a parallel sets representation of the data frequencies and the interactions.

19. The method of claim 17, wherein the graph spatially segregates the traffic flows associated with different communication network devices in at least the subset of the communication network devices or associated with different clients in the one or more clients.

20. The method of claim 17, wherein the method comprises:
receiving user-interface-activity information corresponding to user interaction with a user-interface device; and
modifying the graph based at least in part on the user-interface-activity information.
